(19) United States
(12) Patent Application Publication
(10) Pub. No.: US 2013/0035056 A1
(43) Pub. Date: Feb. 7, 2013

(54) COMMUNICATIONS SYSTEM

(71) Applicants: Anand Raghawa Prasad, Tokyo (JP); Caroline Jactat, Berkshire (GB)

(72) Inventors: Anand Raghawa Prasad, Tokyo (JP); Caroline Jactat, Berkshire (GB)

(73) Assignee: NEC CORPORATION, Minato-ku, Tokyo (JP)

(21) Appl. No.: 13/641,021

(22) PCT Filed: Apr. 13, 2011
(86) PCT No.: PCT/JP2011/059670

§ 371 Date: Oct. 12, 2012

(30) Foreign Application Priority Data
Apr. 15, 2010 (GB) 1006310.5

(51) Int. Cl. H04W 12/08; H04W 4/22; H04W 60/00

(52) U.S. Cl. 455/404.1

(57) ABSTRACT

A cellular communications system is provided in which a user device maintains and provides a last non-emergency security context to a core network when moving from a network that provided restricted services to a network that provides unrestricted services. In this way, re-authentication of the user device can be avoided in the network that provided unrestricted services.

### PRIORITY CLAIM

Priority is claimed on United Kingdom Patent Application No. 1006310.5, filed Apr. 15, 2010, the content of which is incorporated herein by reference.

### TECHNICAL FIELD

The present invention relates to cellular communication methods and apparatus. The invention has particular relevance to cellular devices that operate in accordance with the Long Term Evolution (LTE) of UTRAN (called Evolved Universal Terrestrial Radio Access Network (E-UTRAN)) as well as to the operation of communication nodes within E-UTRAN.

### BACKGROUND ART

In mobile telecommunications networks, there is a requirement for User Equipment (UE, such as a mobile telephone (MT)), that is under radio coverage, always to be able to make emergency calls, even when the UE has no (Universal) Subscriber Identity Module ((U)SIM) card or when registration of the UE to a network has failed. Provision must, therefore, be made within the mobile communications networks to allow UEs to make such emergency calls. When the UE is within the service area of a cell that can provide a normal (un-restricted) service level, the UE must be authenticated before any services (including emergency call services) can be provided. In contrast, when the UE is located in a cell that can only provide a limited (restricted) service to the UE, authentication may be required depending on local regulations because emergency call service is available without subscription. The inventors have realized that this can lead to delays and inefficiencies, especially when the UE is roaming between a restricted service cell and an un-restricted service cell.

FIG. 5 is a communications timing diagram that illustrates the problem. Initially, in step 1, the mobile telephone (MT) is registered with a first Evolved Packet System (EPS) core network that allows the MT unrestricted access to all services. At the time of registration with the first EPS core network, the core network will authenticate the MT and will provide the MT with a Non-Access Stratum (NAS) security context that will allow the MT to access the different services offered by the EPS core network. Subsequently, in step 2, the MT moves to a new location area and the MT performs registration with a second EPS core network. However, the second EPS core network is only able to provide the MT with restricted access to services access to its services (e.g. because the MT's operator does not have roaming agreements with the network operator of the second EPS core network or because the network operator only allows emergency calls in this location area). Therefore, at the time of registration, the second EPS core network sends the MT a new EPS security context indicating NULL security algorithms. This means that the MT is able to make emergency calls, but can not use any other service. If, however, the MT moves back into the service area of the first EPS core network (or into the service area of another network that can provide the MT with an unrestricted service), then at the time of registration, the EPS core network has to perform an authentication process again for the MT in order to allow the MT to have unrestricted access to the available services.

### DISCLOSURE OF INVENTION

According to one aspect, the invention provides a method performed by a mobile communications device, the method comprising: a first registering step of registering, in a normal service mode, with a first cellular network; obtaining a non-emergency security context from the first cellular network; storing the non-emergency security context; a second registering step of registering, in a limited service mode, with a second cellular network; obtaining an emergency security context from the second cellular network; and a third registering step of registering, in the normal service mode, with a third cellular network (which may be the same as the first cellular network); wherein the third registering step includes the step of providing the third cellular network with the non-emergency security context obtained from said first cellular network.

In one embodiment, the providing step includes the non-emergency security context within a tracking area update request that is transmitted to the third cellular network, although in another embodiment, it may be transmitted separately. When registering with the third cellular network, the method may receive a command from the third cellular network to use the non-emergency security context obtained from the first cellular network, although it may specify a new security context.

The invention also provides a method performed by a cellular network, the method comprising: receiving a registration request from a mobile communications device, the registration request including an emergency security context obtained from a current cellular network to which the mobile device is registered in a limited service mode; and registering the mobile communications device with the cellular network; wherein the method further comprises: receiving a non-emergency security context from the mobile communications device; detecting the received non-emergency security context from the mobile communications device; and in response to detecting the received non-emergency security context, registering the mobile communications device without authenticating the mobile communications device.

The non-emergency security context is preferably received with the registration request, which may be in the form of a tracking area update request.

The method may also comprise sending a command to the mobile communications device to use the non-emergency security context received from the mobile communications device.

The invention also provides a mobile communications device comprising: means for registering, in a normal service mode, with a first cellular network; means for obtaining a non-emergency security context from the first cellular network; means for storing the non-emergency security context; means for registering, in a limited service mode, with a second cellular network; means for obtaining an emergency security context from the second cellular network; and means for registering, in the normal service mode, with a third cellular network; wherein the means for registering with a third cellular network includes means for providing the third cellular network with the non-emergency security context obtained from said first cellular network.

The invention also provides a communications node of a cellular network comprising: means for receiving a registration request from a mobile communications device, the registration request including an emergency security context obtained from a current cellular network to which the mobile device is registered in a limited service mode; and means for registering the mobile communications device with the cellular network; wherein the communications node further comprises: means for receiving a non-emergency security context from the mobile communications device; means for detecting the received non-emergency security context from the mobile communications device; and means, responsive to the detection of the received non-emergency security context, for registering the mobile communications device without authenticating the mobile communications device.

The invention also provides a mobile communications device that has a normal operating mode when registered with a cellular network that provides unrestricted access to communication services and a limited service operating mode when registered with a cellular network that provides restricted service to communication services, wherein the mobile communications device is configured such that when the mobile communications device is roaming from a cellular network that provides restricted access to a cellular network that provides unrestricted access, the mobile communications device transmits a previously obtained non-emergency security context to the cellular network that provides unrestricted access.

The present invention also provides a computer implementable instructions product comprising computer implementable instructions for causing a programmable computer device to become configured as the above mobile device or as the above communications node. The product may include a computer readable medium or a signal that carries the instructions.

### BRIEF DESCRIPTION OF THE DRAWINGS

These and various other aspects of the invention will become apparent from the following detailed description of embodiments which are described, by way of example only, with reference to the accompanying drawings in which:

FIG. 1 schematically illustrates a mobile telecommunication system of a type to which the embodiment is applicable;

FIG. 2 is a block diagram illustrating components of a E-UTRA Radio Access Network and Core network forming part of the system shown in FIG. 1;

FIG. 3 is a block diagram illustrating components of a mobile communication device forming part of the system shown in FIG. 1;

FIG. 4 is a communications timing diagram illustrating the communications between the mobile communications device and the first and second core networks illustrated in FIG. 1; and

FIG. 5 is a communications timing diagram illustrating the communications between a mobile communications device and first and second core networks in an existing communications system.

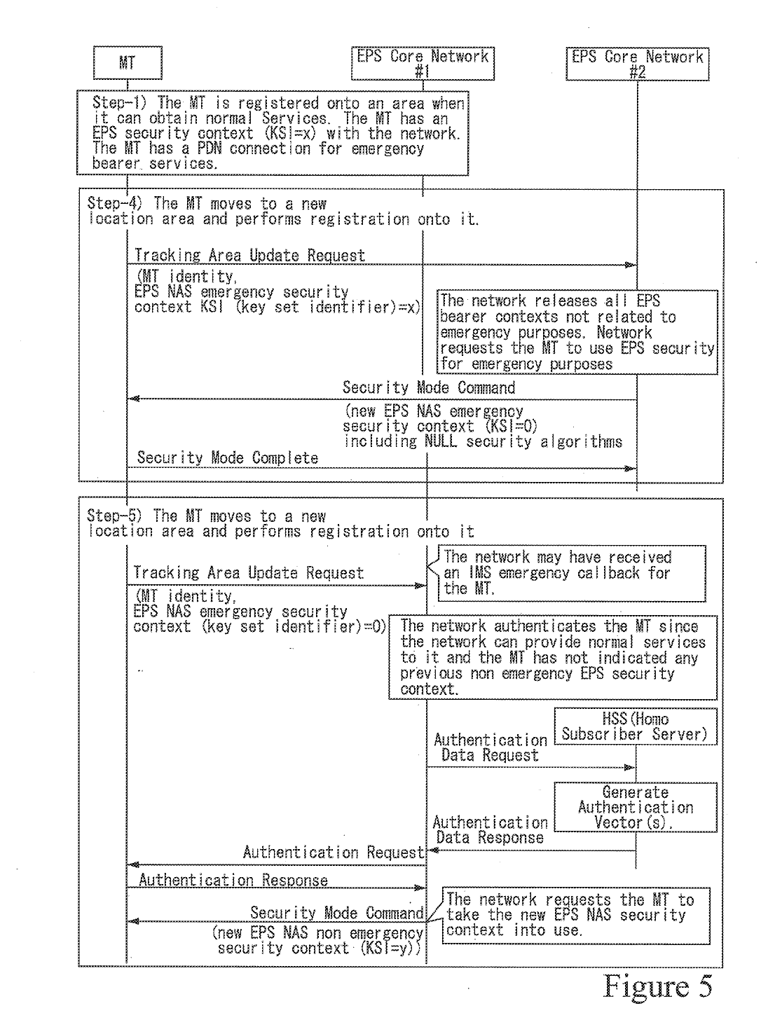

### EMBODIMENTS FOR CARRYING OUT THE INVENTION

### Overview

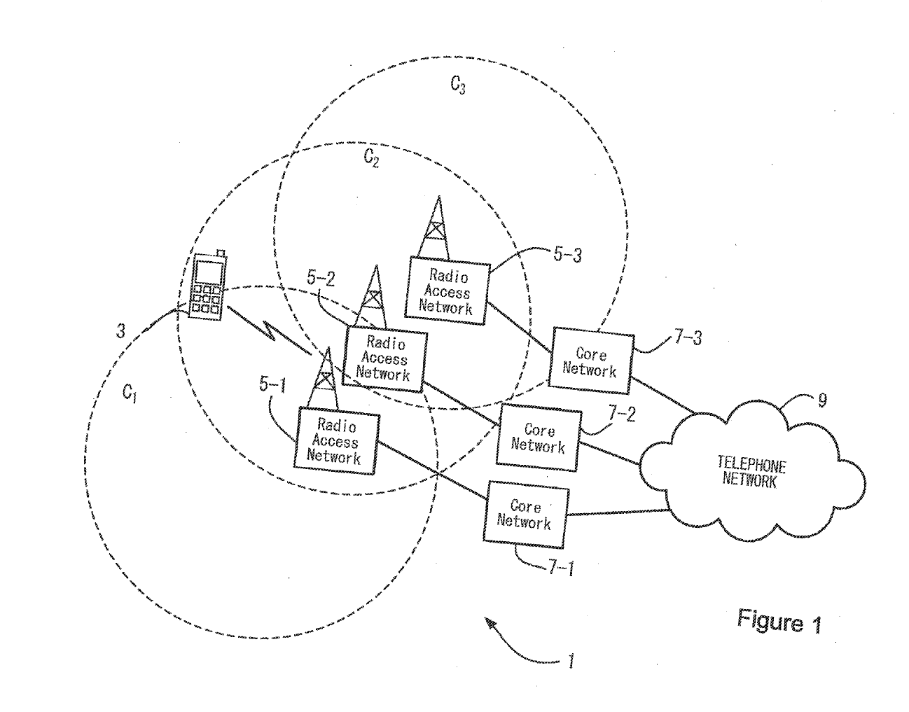

FIG. 1 schematically illustrates part of a mobile (cellular) telecommunications system 1 having a mobile telephone 3, three radio access networks 5-1, 5-2 and 5-3 and corresponding core networks 7-1, 7-2 and 7-3 and the telephone network 9. Each of the radio access networks 5 operates to communicate with mobile telephones 3 within a respective cell, which are illustrated in FIG. 1 by the dashed circles labeled C₁, C₂ and C₃, respectively. In the illustrated FIG. 1, the mobile telephone 3 is moving from cell C₁ to cell C₂. In this embodiment, cell C₂ can not provide normal service to the mobile telephone 3 and so when the mobile telephone registers with cell C₂ it will register itself in its limited service mode in which only emergency calls can be made. Cells C₁ and C3 can both provide the mobile telephone 3 with a normal service. Therefore, when the mobile telephone 3 moves from ceil C₂ into either of cells C₁ or C₃ a normal service can resume.

As will be described in more detail below, it is proposed that in the above situation, when the mobile telephone 3 moves to cell C₁ or C₃ from cell C₂, the mobile telephone 3 indicates the presence of an EPS NAS security context (obtained when the mobile telephone 3 was authenticated in cell C₁ before it moved into cell C₂) at the time of registration, so that the EPS core network 7 does not need to re-authenticate the mobile telephone 3.

### Radio Access Network & Core Network

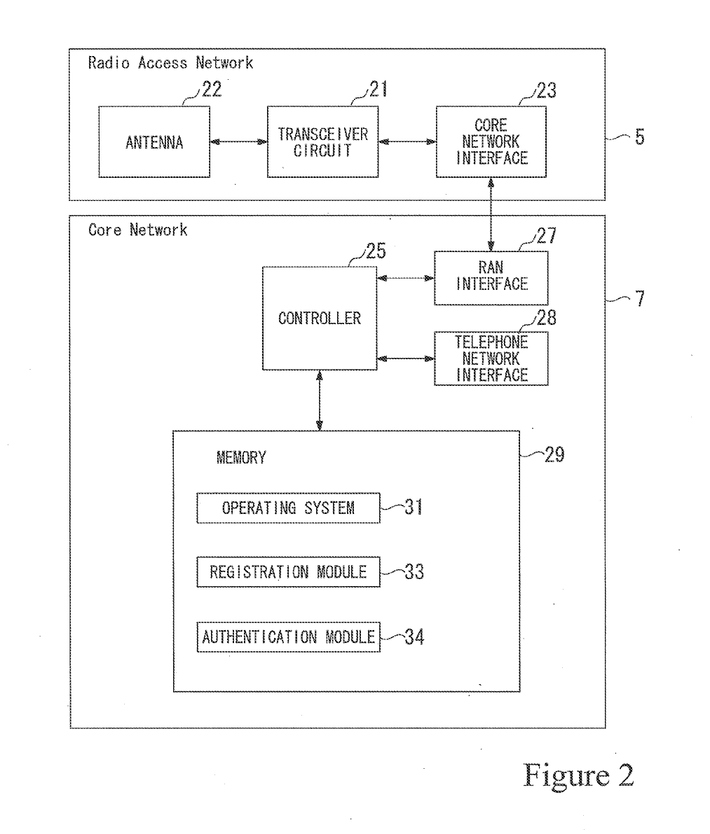

Although each radio access network 5 may operate a number of different cells, each providing different services to the mobile telephone 3, in this embodiment it will be assumed that each radio access network 5 operates a single cell. FIG. 2 is a block diagram illustrating the main components of one of the radio access networks 5 and core networks 7 used in this embodiment. As shown, radio access network 5 includes a transceiver circuit 21 which is operable to transmit signals to and to receive signals from the mobile telephone 3 via one or more antennae 22 and which is operable to transmit signals to and to receive signals from the core network 7 via a core network interface 23. The radio access network 5-2 will also include a controller which controls the operation of the radio access network 5-2 in accordance with software stored in memory, although these have not been shown for simplicity.

The core network 7 includes a controller 25 which controls the operation of the core network 7 and which is operable to transmit data to and to receive data from the radio access network (RAN) 5 via a RAN interface 27, and which is operable to transmit data to and to receive data from the telephone network 9 via a telephone network interface 28. As shown, the controller 25 controls the operation of the core network 7 in accordance with software stored in memory 29. The software includes, among other things, an operating system 31, a registration module 33 and an authentication module 34. The registration module 33 maintains records of the mobile telephones 3 that are registered with the corresponding radio access network 5 and their service state (e.g. NORMAL SERVICE or LIMITED SERVICE); and the authentication module 34 authenticates mobile telephones 3 and establishes the NAS security context for a mobile telephone 3 at the time of registration.

### Mobile Telephone

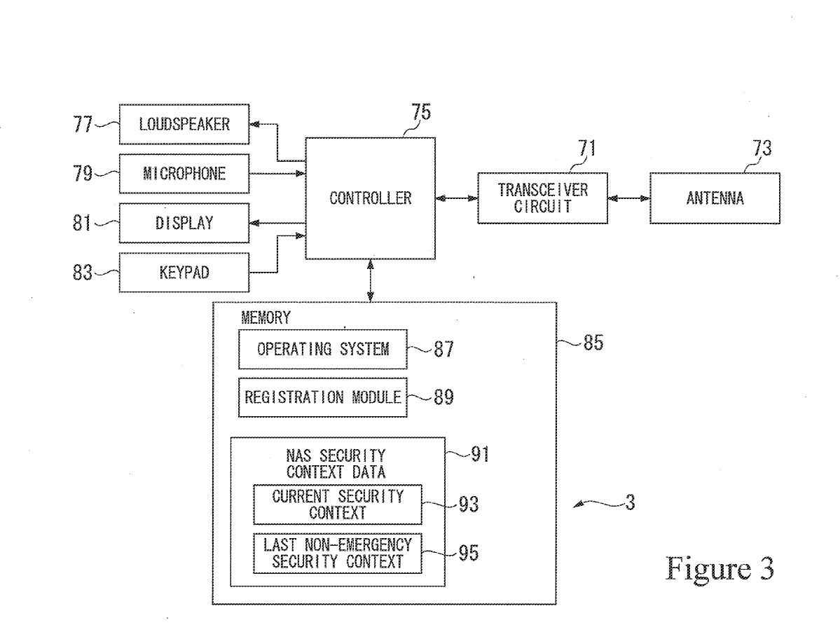

FIG. 3 schematically illustrates the main components of the mobile telephone 3 shown in FIG. 1. As shown, the mobile telephone 3 includes a transceiver circuit 71 that is operable to transmit signals to and to receive signals from the selected radio access network 5 via one or more antennae 73. As shown, the mobile telephone 3 also includes a controller 75 which controls the operation of the mobile telephone 3 and which is connected to the transceiver circuit 71 and to a loudspeaker 77, a microphone 79, a display 81, and a keypad 83. The controller 75 operates in accordance with software modules stored within memory 85. As shown, these software modules include, among other things, an operating system 87 and a registration module 89. The memory also maintains NAS security context data 91, that includes the current security context 93 for the current EPS core network 7 and a last non-emergency security context 95 for use when moving to a network where unrestricted services are provided (e.g. cell C₁ or C₃ in this embodiment) from a network where restricted services were provided (e.g. cell C₂). The registration module 89 is responsible for registering the mobile telephone 3 with the different network cells and, where appropriate, for providing the stored previous security context data 91.

In the above description, both the core network 7 and the mobile telephone 3 are described, for ease of understanding, as having various discrete software modules. Whilst these software modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities.

### Operation

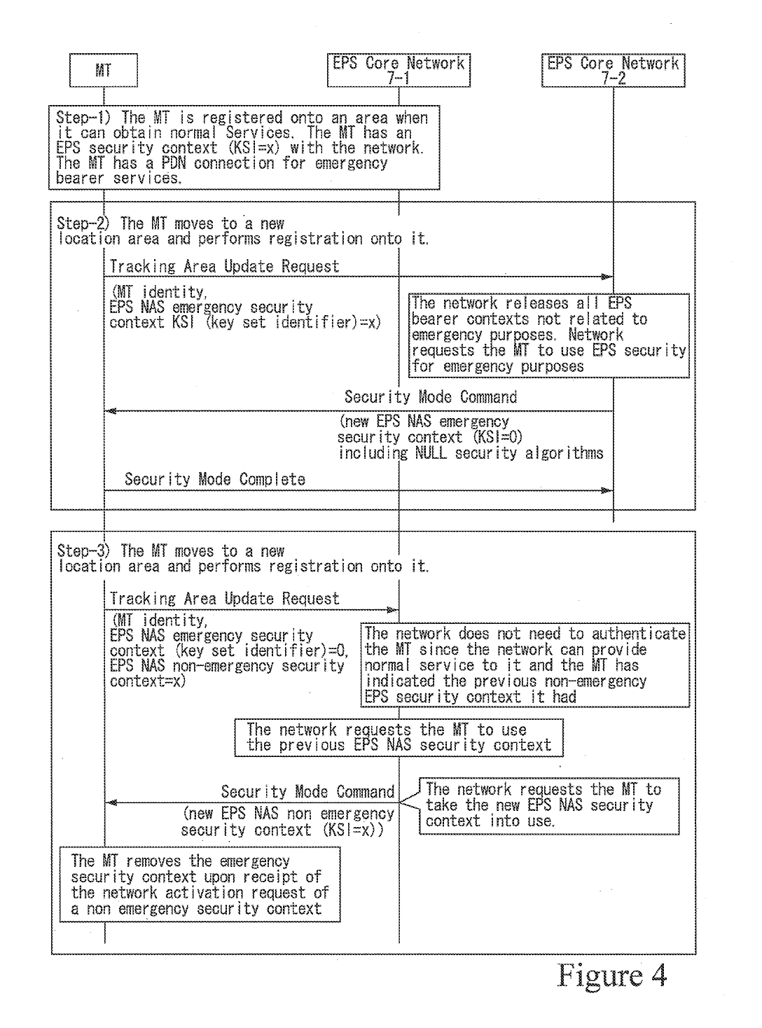

An example scenario illustrating the operation of the invention will now be described in more detail with reference to FIG. 4. As shown, in step 1, the MT 3 is registered with EPS core network 7-1 where it can receive normal services. In accordance with the communication protocol of EPS core network 7-1, the MT 3 will have been authenticated and will have been provided with a non-emergency EPS security context (Key Set Identifier (KSI)=x). As EPS core network can provide a normal service to the MT 3, the received security context is stored as both the current security context 93 and as the non-emergency security context 95 within the memory 85. In this example scenario, it is assumed that the MT 3 has requested an IP Multimedia Subsystem (IMS) emergency call and that an appropriate Packet Data Network (PDN) connection for emergency bearer services has been setup by the EPS core network 7-1. The MT 3 may then request release of the IMS emergency call but the network may keep the PDN connection for emergency purposes for a certain amount of time so that, for example, the MT 3 can be called back by the emergency service.

If the MT then moves, in step 2, into the location area served by cell C₂, then the MT 3 will register with EPS core network 7-2 by sending it a NAS tracking area update request. This request will include the MT's identity and the current security context 93 (KSI=x) provided by EPS core network 7-1. As mentioned above, in this embodiment, the EPS core network 7-2 is only able to provide MT 3 with a restricted service. The EPS core network 7-2, therefore releases all EPS bearer contexts. The EPS core network 7-2 then sends the MT 3 a security mode command that defines a new emergency security context (KSI=0) including NULL algorithms so that the MT 3 is only able to make outgoing emergency calls. The MT 3 stores this new security context in the current security context 93 stored in memory 85. As the new core network does not provide non-emergency services, the non-emergency security context 95 is not updated.

At step 3, the MT 3 then moves back into the location area served by cell C₁ and requests to register with EPS core network 7-1 by sending a tracking area update request. This request includes the MT's identity as well as the current security context 93 (in this case emergency security context KSI=0). In this embodiment, as the current EPS core network 7-2 only provides an emergency call service, the request also includes the security context for the last unrestricted cell with which the MT 3 was registered. In this example, that is the security context that was established the last time, the MT 3 was registered with EPS core network 7-1 (KSI=x) and is stored in non- emergency security context 95 within memory 85. When the EPS core network 7-1 detects this non-emergency security context in the tracking area update message, it will still have this non-emergency security context associated with the MT 3 within its memory. Provided the security context received from the MT 3 matches that stored within the EPS core network 7, the EPS core network 7-1 knows that it has already authenticated the MT 3 and so it does not need to re-authenticate the MT 3 and can just request the MT to use the previous non-emergency security context (KSI=x). Therefore, as the EPS network 7-1 can register the MT without having to re-authenticate the MT 3, the additional authentication delay (authentication vector(s) fetch from the Home Subscriber Server (HSS) and authentication procedure towards the MT 3 including the MT's access to its US1M) can be avoided before another IMS emergency call can be established.

### Modifications and Alternatives

A detailed embodiment has been described above. As those skilled in the art will appreciate, a number of modifications and alternatives can be made to the above embodiment whilst still benefiting from the invention embodied therein. By way of illustration only a number of these alternatives and modifications will now be described.

In the above embodiments, a number of software modules were described. As those skilled will appreciate, the software modules may be provided in compiled or un-compiled form and may be supplied to the core network, radio access network or to the mobile telephone as a signal over a computer network, or on a recording medium. Further, the functionality performed by part or all of this software may be performed using one or more dedicated hardware circuits. However, the use of software modules is preferred as it facilitates the updating of radio access network 5 and the mobile telephone 3 in order to update their functionalities.

In the above embodiment, the mobile telephone 3 moved from EPS core network 7-1 to EPS core network 7-2 and then back again to EPS core network 7-1. By configuring the mobile telephone 3 to store and provide the last non-emergency security context to the new core network at the time of registration, the EPS core network 7-1 does not have to re-authenticate the mobile telephone 3. As those skilled in the art will appreciate, the same advantage will be obtained if the mobile telephone moved from cell C₁ then to cell C₂ and then to cell C₃. In this case, however, the EPS core network 7-3 would use the mobile telephone ID contained within the tracking area update request to obtain the non-emergency security context (KSI=x) from the previous unrestricted EPS core network 7-1. Provided it matches the one received from the mobile telephone 3, then the EPS core network 7-3 does not need to re-authenticate the mobile telephone 3.

In the above embodiment, the MT informed the new core network of the last non-emergency security context in the tracking area update request. As those skilled in the art will appreciate, this information may be provided to the new core network in another message if desired. However, it is preferred to include the information in the tracking area update request as this is the easiest to implement.

In the above embodiment, a mobile telephone was provided that communicated with a number of radio access networks. As those skilled in the art will appreciate, the invention is applicable to other types of user equipment (UE) such as laptop computers, Personal Digital Assistants or other hand held portable computer devices.

In the above embodiment, each radio access network was connected to their own core network 7. As those skilled in the art will appreciate, a cell can be part of a network sharing architecture in which there may be several core networks 7 that use the same cell.

### INDUSTRIAL APPLICABILITY

The present invention can be applied to cellular communication methods and apparatus. More particularly, the invention may be applied to cellular devices that operate in accordance with the LTE of UTRAN (called E-UTRAN) as well as to the operation of communication nodes within E-UTRAN so as to avoid re-authentication of the cellular device in the network that provided unrestricted services.

1. A method performed by a mobile communications device, the method comprising:
a first registering step of registering, in a normal service mode, with a first cellular network;
obtaining a non-emergency security context from the first cellular network;
storing the non-emergency security context;
a second registering step of registering, in a limited service mode, with a second cellular network;
obtaining an emergency security context from the second cellular network; and
a third registering step of registering, in the normal service mode, with a third cellular network;
wherein the third registering step includes the step of providing the third cellular network with the non-emergency security context obtained from said first cellular network.

2. A method according to claim 1, wherein said providing step includes said non-emergency security context within a tracking area update request that is transmitted to the third cellular network.

3. A method according to claim 1, wherein said third registering step includes the step of receiving a command from the third cellular network to use the non-emergency security context obtained from the first cellular network.

4. A method according to claim 3, comprising removing the emergency security context upon reception of the network command from the third cellular network to use the non-emergency security context obtained from the first cellular network.

5. A method according to claim 1, wherein the first and third cellular networks are the same cellular network.

6. A method performed by a cellular network, the method comprising:
receiving a registration request from a mobile communications device, the registration request including an emergency security context obtained from a current cellular network to which the mobile device is registered in a limited service mode; and
registering the mobile communications device with the cellular network;
wherein the method further comprises:
receiving a non-emergency security context from the mobile communications device;
detecting the received non-emergency security context from the mobile communications device; and
in response to detecting the received non-emergency security context, registering the mobile communications device without authenticating the mobile communications device if the cellular network has an indicated non-emergency security context.

7. A method according to claim 6, wherein the non-emergency security context is received with the registration request.

8. A method according to claim 6, wherein said registration request comprises a tracking area update request.

9. A method according to claim 6, comprising sending a command to the mobile communications device to use the non-emergency security context received from the mobile communications device.

10. A mobile communications device comprising:
means for registering, in a normal service mode, with a first cellular network;
means for obtaining a non-emergency security context from the first cellular network;
means for storing the non-emergency security context;
means for registering, in a limited service mode, with a second cellular network;
means for obtaining an emergency security context from the second cellular network; and
means for registering, in the normal service mode, with a third cellular network;
wherein the means for registering with a third cellular network includes means for providing the third cellular network with the non-emergency security context obtained from said first cellular network.

11. A device according to claim 10, wherein said providing means is operable to include said non-emergency security context within a tracking area update request that is transmitted to the third cellular network.

12. A device according to claim 10, wherein said means for registering with the third cellular network includes the means for receiving a command from the third cellular network to use the non-emergency security context obtained from the first cellular network.

13. A device according to claim 12, operable to remove the emergency security context upon reception of the network command from the third cellular network to use the non-emergency security context obtained from the first cellular network.

14. A device according to claim 10, wherein the first and third cellular networks are the same cellular network.

15. A communications node of a cellular network comprising:
means for receiving a registration request from a mobile communications device, the registration request including an emergency security context obtained from a current cellular network to which the mobile device is registered in a limited service mode; and
means for registering the mobile communications device with the cellular network;
wherein the communications node further comprises:
means for receiving a non-emergency security context from the mobile communications device;
means for detecting the received non-emergency security context from the mobile communications device; and
means, responsive to the detection of the received non-emergency security context, for registering the mobile communications device without authenticating the mobile communications device if the cellular network has an indicated non-emergency security context.

16. A communications node according to claim 15, operable to receive the non-emergency security context with the registration request.

17. A communications node according to claim 15, wherein said registration request comprises a tracking area update request.

18. A communications node according to claim 15, comprising means for sending a command to the mobile communications device to use the non-emergency security context received from the mobile communications device.

19. A mobile communications device that has a normal operating mode when registered with a cellular network that provides unrestricted access to communication services and a limited service operating mode when registered with a cellular network that provides restricted service to communication services, the mobile communications device comprising a controller which is configured such that when the mobile communications device is roaming from a cellular network that provides restricted access to a cellular network that provides unrestricted access, the mobile communications device transmits a previously obtained non-emergency security context to the cellular network that provides unrestricted access.

20. A computer implementable instructions product comprising computer implementable instructions for causing a programmable computer device to perform the method of claim 1.
